(19) United States
(12) Patent Application Publication
(10) Pub. No.: US 2024/0143992 A1
(43) Pub. Date: May 2, 2024

(54) HYPERPARAMETER TUNING WITH DYNAMIC PRINCIPAL COMPONENT ANALYSIS

(71) Applicant: Dell Products L.P., Round Rock, TX (US)

(72) Inventors: Bing YUAN, Cork (IE); Peter P. O'BRIEN, Cork (IE); Ally Junio Oliveira BARRA, Cork (IE)

(73) Assignee: Dell Products L.P., Round Rock, TX (US)

(21) Appl. No.: 17/975,108

(22) Filed: Oct. 27, 2022

(51) Int. Cl. G06N 3/08

(52) U.S. Cl. CPC G06N 3/08

(57) ABSTRACT

An information handling system may include at least one processor and a non-transitory memory coupled to the at least one processor. The information handling system may be configured to: receive information regarding a set of variables relating to a machine learning task for analyzing a target variable; perform principal component analysis (PCA) on the set of variables to determine a reduced set of variables; in response to a change in the plurality of variables, dynamically update the reduced set of variables; and determine at least one hyperparameter for the machine learning task based on the dynamically updated reduced set of variables.

### TECHNICAL FIELD

The present disclosure relates in general to information handling systems, and more particularly to the management of machine learning systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on a cluster of standard, off-the-shelf servers referred to as nodes or hosts. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

Some embodiments of this disclosure may employ artificial intelligence (AI) techniques such as machine learning, deep learning, natural language processing (NLP), etc. Generally speaking, machine learning encompasses a branch of data science that emphasizes methods for enabling information handling systems to construct analytic models that use algorithms that learn interactively from data. It is noted that, although disclosed subject matter may be illustrated and/or described in the context of a particular AI paradigm, such a system, method, architecture, or application is not limited to those particular techniques and may encompass one or more other AI solutions.

In the creation of a machine learning model, many design choices may arise as to how to define the model architecture. Often, it is not known a priori what the optimal model architecture should be for a given model, and thus it would be advantageous to be able to explore the space of possibilities. Parameters that define the model architecture are referred to herein as hyperparameters, and thus this process of searching for the ideal model architecture (e.g., choosing a set of optimal hyperparameters for a learning algorithm) is referred to as hyperparameter tuning.

For purposes of this disclosure, a hyperparameter is a parameter that has a value which is set before the learning process begins. Some non-limiting examples of hyperparameters may include penalty in logistic regression, loss in stochastic gradient descent, the degree of polynomial features to be used for a linear model, the maximum depth that should be allowed for a decision tree, the minimum number of samples required at a leaf node in a decision tree, the number of trees included in a random forest, the number of neurons included in a neural network layer, the number of layers included in a neural network, the learning rate for gradient descent, etc.

Even for relatively simple algorithms like linear regression, it can be difficult to find the best set of hyperparameters. With more complicated algorithms like deep learning, it is much more difficult.

Accordingly, embodiments of this disclosure may provide improvements in the determination of hyperparameters used in machine learning.

Embodiments may rely on principal component analysis (PCA). As one of ordinary skill in the art with the benefit of this disclosure will appreciate, PCA addresses the situation in which data becomes sparse in a high-dimensional space, which may cause issues with algorithms that are not designed to handle such complicated spaces. To achieve the goal of dimensionality reduction, techniques such as PCA may be employed. The feature extraction approach of PCA seeks to transform the high-dimensional features into a new space of lower dimensionality by a linear combination of the original set of features.

Embodiments may dynamically determine the most correlated variables, which may then be used to generate a fresh training data set for hyperparameter tuning steps. This may reduce the amount of manual work required to obtain the PCA results, and the PCA results may then be automatically used for hyperparameter tuning (e.g., without any human interaction required).

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with the management of machine learning systems may be reduced or eliminated.

In accordance with embodiments of the present disclosure, an information handling system may include at least one processor and a non-transitory memory coupled to the at least one processor. The information handling system may be configured to: receive information regarding a set of variables relating to a machine learning task for analyzing a target variable; perform principal component analysis (PCA) on the set of variables to determine a reduced set of variables; in response to a change in the plurality of variables, dynamically update the reduced set of variables; and determine at least one hyperparameter for the machine learning task based on the dynamically updated reduced set of variables.

In accordance with these and other embodiments of the present disclosure, a method may include an information handling system receiving information regarding a set of variables relating to a machine learning task for analyzing a target variable; the information handling system performing principal component analysis (PCA) on the set of variables to determine a reduced set of variables; in response to a change in the plurality of variables, the information handling system dynamically updating the reduced set of variables; and the information handling system determining at least one hyperparameter for the machine learning task based on the dynamically updated reduced set of variables.

In accordance with these and other embodiments of the present disclosure, an article of manufacture may include a non-transitory, computer-readable medium having computer-executable code thereon that is executable by an information handling system for: receiving information regarding a set of variables relating to a machine learning task for analyzing a target variable; performing principal component analysis (PCA) on the set of variables to determine a reduced set of variables; in response to a change in the plurality of variables, dynamically updating the reduced set of variables; and determining at least one hyperparameter for the machine learning task based on the dynamically updated reduced set of variables.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates an example method, in accordance with embodiments of the present disclosure.

### DETAILED DESCRIPTION

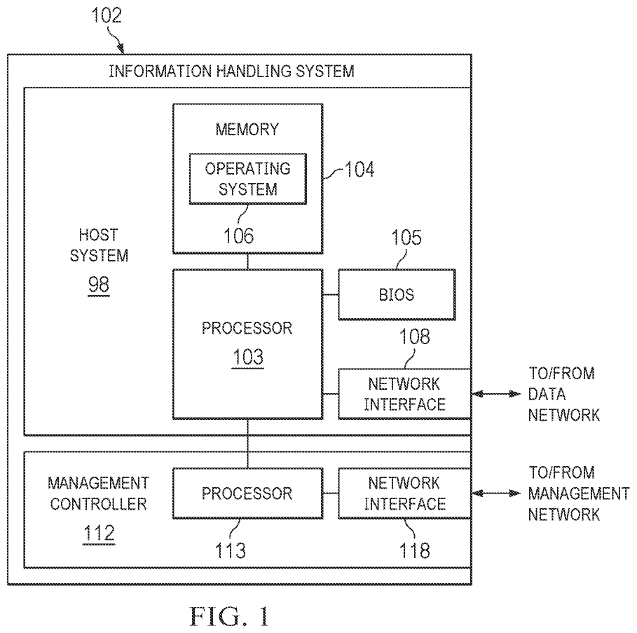

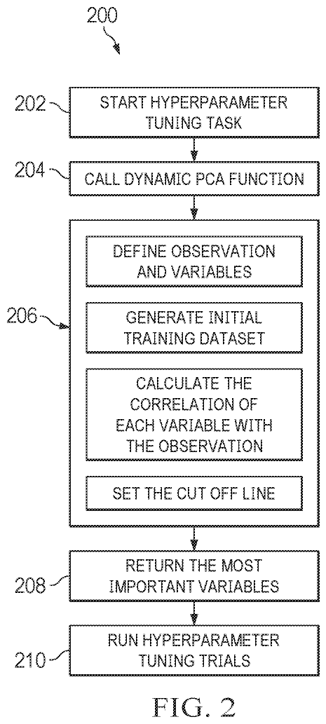

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102 (e.g., by a user operating a management console). Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure may provide improvements in the determination of hyperparameters used in machine learning.

Data scientists sometimes use PCA before fitting data to a machine learning model. Embodiments of this disclosure may dynamically reduce the number of features to generate a training data set, which may be helpful in hyperparameter tuning.

PCA is a multivariate technique that analyzes a data table in which observations are described by several inter-correlated quantitative dependent variables. An observation (also referred to as a case, record, pattern, or row) is the unit of analysis on which measurements are taken (e.g., a customer, a transaction, etc.). Typically, each row represents a record within a data set/table, while each column represents a variable.

PCA helps determine which variables should be retained, and the correlation between the target variable (which the machine learning model is trying to predict) and the rest of the variables. PCA allows for extracting the most important information from the data table, compressing the size of the data set by keeping only the most important variables, simplifying the description of the data set, and analyzing the structure of the observations and the variables.

For example, when predicting the time required to perform a lifecycle management upgrade (e.g., a software and/or firmware upgrade) in an HCI cluster, the relevant variables might include quantities such as the number of hosts, number of CPU cores, number of VMs, the current software version, the target software version, etc. PCA allows for a determination of which variables most highly correlate with the target variable (the total upgrade time), and how many variables need to be taken into account to obtain a sufficiently predictive model. For example, it may be the case that only a small number of variables account for the vast majority of the variance in the target variable, with the remaining variables providing only weak dependencies.

In one embodiment, a training data set may be used to train a machine learning model to perform a desired task. The training data set is used when determining the most correlated variables via PCA. If the PCA result indicates that only a particular subset of the variables are strongly correlated to the target variable, then a new training data set may be created, which contains only that subset of variables. This new data set may then be used for hyperparameter tuning to improve the accuracy of the model.

In one embodiment, the PCA results may also be dynamically updated when the source data set changes, rather than requiring further manual PCA iterations. In particular, a change of variables (e.g., an addition or removal of one or more variables) may be incorporated into the PCA results efficiently without the need for changing existing PCA code.

One embodiment may define an input list including one or more input variables and one or more target variables, each including a name and a type. For example, in the example discussed above, the variable representing the number of hosts might have the name “numHosts” and an integer type. The remaining variables may likewise by named and typed. A training data set may then be generated based on the variables list. Any time the variables defined for PCA analysis changes, the training data set may be automatically recalculated.

Each variable's correlation with the target variable may then be calculated. For example, a PCA calculation may set the quantity of variables to some number N, and the explained variance of all the generated components may be determined. In one embodiment, this may be accomplished by setting some cutoff percentage for the amount of variance explanation desired (e.g., 99%), and PCA may then determine the number N of the most important variables needed to explain that 99% of the variance.

These N most-important variables may then be returned as the PCA results. The corresponding features may then be automatically selected and used as the input data for the hyperparameter tuning process. For example, the hyperparameter tuning process for specifying the machine learning model may itself be implemented as a machine learning problem.

Turning now to FIG. 2, an example method 200 is shown for incorporating PCA into the hyperparameter tuning process as discussed above. At step 202, a hyperparameter tuning task may be started.

At step 204, a dynamic PCA function may be invoked. The dynamic PCA function execute and return the most important N variables as shown at steps 206 and 208. Finally, hyperparameters for a machine learning model may be tuned based on the results at step 210.

One of ordinary skill in the art with the benefit of this disclosure will understand that the preferred initialization point for the method depicted in FIG. 2 and the order of the steps comprising that method may depend on the implementation chosen. In these and other embodiments, this method may be implemented as hardware, firmware, software, applications, functions, libraries, or other instructions. Further, although FIG. 2 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Accordingly, embodiments may provide many benefits. The quantity N of the most important variables for the machine learning model may be selected automatically without requiring any change to existing PCA code. Further, there may be no need for a user to manually run PCA every time the input variables change. Still further, by allowing hyperparameter tuning to execute seamlessly with PCA, potential human errors are avoided, making the machine learning hyperparameter tuning more reliable and efficient.

Although various possible advantages with respect to embodiments of this disclosure have been described, one of ordinary skill in the art with the benefit of this disclosure will understand that in any particular embodiment, not all of such advantages may be applicable. In any particular embodiment, some, all, or even none of the listed advantages may apply.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a non-transitory memory coupled to the at least one processor;
wherein the information handling system is configured to:
receive information regarding a set of variables relating to a machine learning task for analyzing a target variable;
perform principal component analysis (PCA) on the set of variables to determine a reduced set of variables;
in response to a change in the plurality of variables, dynamically update the reduced set of variables; and
determine at least one hyperparameter for the machine learning task based on the dynamically updated reduced set of variables.

2. The information handling system of claim 1, wherein the machine learning task is a deep learning task.

3. The information handling system of claim 1, wherein the machine learning task is implemented via a neural network.

4. The information handling system of claim 1, wherein the at least one hyperparameter is selected from the group consisting of a logistic regression penalty, a stochastic gradient descent loss, a degree of a polynomial for a linear model, a maximum depth for a decision tree, a minimum number of samples for a leaf node in a decision tree, a number of trees in a random forest, a number of neurons in a neural network layer, a number of layers in a neural network, and a gradient descent learning rate.

5. The information handling system of claim 1, wherein the target variable is a time required for a lifecycle management event.

6. The information handling system of claim 1, wherein the information handling system is a node of a hyperconverged infrastructure (HCI) cluster.

7. A method comprising:
an information handling system receiving information regarding a set of variables relating to a machine learning task for analyzing a target variable;
the information handling system performing principal component analysis (PCA) on the set of variables to determine a reduced set of variables;
in response to a change in the plurality of variables, the information handling system dynamically updating the reduced set of variables; and
the information handling system determining at least one hyperparameter for the machine learning task based on the dynamically updated reduced set of variables.

8. The method of claim 7, wherein the machine learning task is a deep learning task.

9. The method of claim 7, wherein the machine learning task is implemented via a neural network.

10. The method of claim 7, wherein the at least one hyperparameter is selected from the group consisting of a logistic regression penalty, a stochastic gradient descent loss, a degree of a polynomial for a linear model, a maximum depth for a decision tree, a minimum number of samples for a leaf node in a decision tree, a number of trees in a random forest, a number of neurons in a neural network layer, a number of layers in a neural network, and a gradient descent learning rate.

11. The method of claim 7, wherein the target variable is a time required for a lifecycle management event.

12. The method of claim 11, wherein the information handling system is a node of a hyperconverged infrastructure (HCI) cluster.

13. An article of manufacture comprising a non-transitory, computer-readable medium having computer-executable code thereon that is executable by an information handling system for:
receiving information regarding a set of variables relating to a machine learning task for analyzing a target variable;
performing principal component analysis (PCA) on the set of variables to determine a reduced set of variables;
in response to a change in the plurality of variables, dynamically updating the reduced set of variables; and
determining at least one hyperparameter for the machine learning task based on the dynamically updated reduced set of variables.

14. The article of claim 13, wherein the machine learning task is a deep learning task.

15. The article of claim 13, wherein the machine learning task is implemented via a neural network.

16. The article of claim 13, wherein the at least one hyperparameter is selected from the group consisting of a logistic regression penalty, a stochastic gradient descent loss, a degree of a polynomial for a linear model, a maximum depth for a decision tree, a minimum number of samples for a leaf node in a decision tree, a number of trees in a random forest, a number of neurons in a neural network layer, a number of layers in a neural network, and a gradient descent learning rate.

17. The article of claim 13, wherein the target variable is a time required for a lifecycle management event.

18. The article of claim 17, wherein the information handling system is a node of a hyperconverged infrastructure (HCI) cluster.
